(19) United States
(12) Patent Application Publication
(10) Pub. No.: US 2016/0360730 A1
(43) Pub. Date: Dec. 15, 2016

(54) CONFIGURATION-VARIABLE REMOTE-CONTROLLED PET TOY

(71) Applicant: JIANGSU FAVORITE LEISURE ARTICLES CO., LTD., Jiangsu (CN)

(72) Inventor: Hao SHI, Jiangsu (CN)

(73) Assignee: JIANGSU FAVORITE LEISURE ARTICLES CO., LTD., Jiangsu (CN)

(21) Appl. No.: 15/172,112

(22) Filed: Jun. 2, 2016

(30) Foreign Application Priority Data
Jun. 2, 2015 (CN) 201520371976.X

(51) Int. Cl. A01K 15/02; G08C 17/02; A63H 11/00; A63H 30/04; A63H 5/00

(52) U.S. Cl. CPC A01K 15/025; A63H 30/04; A63H 5/00; A63H 11/00; G08C 17/02

(57) ABSTRACT

A configuration-variable remote-controlled pet toy includes a movable base, an animal model detachably installed on the base, and an external control terminal, wherein the bottom of the base is provided with a roller wheel, the inside of the base is provided with a motor, a control circuit, a micro control unit, a wireless communication module and a phonation device; the motor is configured to drive the roller wheel to roll, the control circuit controls the rotation of the motor according to a control signal sent by the micro control unit, the wireless communication module is communicated with the external control terminal, and the phonation device is configured to play the sound or sound record of a master received by the wireless communication module in real time.

### CROSS-REFERENCE TO RELATED APPLICATIONS

This Application claims the priority of Chinese Patent Application No. 201520371976.X, filed on Jun. 2, 2015, the disclosure of which is incorporated by reference in its entirety.

### TECHNICAL FIELD

The invention relates to a pet toy, and more particularly, to a configuration-variable remote-controlled pet toy.

### BACKGROUND ART

Raising pets is very universal and common in the present society, and has become a very important way of enjoyment for people. People and pets have established an important relationship, and the intimating degree of this relationship may even beyond family affection, friendship and love sometimes because the relationship between the two is very simple but subtle. The pets as partner animals of we human beings is one resource for we human beings to gain happy and healthy life, and raising pets may make the life of people healthier and more fulfilling. Particularly for some solitary old people, raising pets is beneficial for their physical and psychological health, and communication with the pets makes the life of the old people more fulfilling.

However, most pets are natured to be active, and like to play and run, with which the old people cannot keep up; as a result, the pets can only play with toys during most of the time. But, multiple toys are initiatively toggled by the pets themselves, which cannot attract the pets to play for a long term; moreover, there is lack of communication between the pets and the master.

### SUMMARY OF THE INVENTION

An object of the invention is to provide a configuration-variable remote-controlled pet toy with respect to the foregoing problems, which can be remotely controlled by a mobile phone or a tablet, and integrate the functions of image shooting and phonation.

An object of the invention may be implemented as follows.

A configuration-variable remote-controlled pet toy includes a movable base, an animal model detachably installed on the base, and an external control terminal.

The bottom of the base is provided with a roller wheel, the inside of the base is provided with a motor, a control circuit, a micro control unit, a wireless communication module and a phonation device. The motor is configured to drive the roller wheel to roll, the control circuit controls the rotation of the motor according to a control signal sent by the micro control unit, the wireless communication module is communicated with the external control terminal, and the phonation device is configured to play the sound or sound record of a master.

Wherein, the head of the animal model is provided with a wireless camera lens that can be communicated with the external control terminal.

Wherein, the wireless camera lens is detachably installed on the head of the animal model.

Wherein, the top of the base is provided with an installation column which is vertically raised towards the upper side, and the bottom of the animal model is provided with a recess platform corresponding to the installation column; and the animal model is fixed on the base through the buckling of the recess platform and the installation column.

Wherein, the base is provided with a battery installation box that can be downwards opened.

Wherein, the wireless communication module communicates via WiFi or bluetooth.

Wherein, the external control terminal is a movable control terminal.

Wherein, the movable control terminal is a smartphone or a tablet.

The invention has the advantageous effects that: a user may remotely control the running of the pet toy via a smartphone or tablet, so as to attract the pet to play, can see the playing situation between the pet and the toy via the camera lens, and may also send an instruction or play a sound record to the pet through the phonation device to attract the pet.

### BRIEF DESCRIPTION OF THE DRAWINGS

FIG. 1 is a block diagram of one embodiment of the invention.

FIG. 2 is an installation drawing of a base and an animal model in accordance with one embodiment of the invention.

FIG. 3 is a block diagram of one embodiment of the invention after replacing an animal model.

### DETAILED DESCRIPTION

Embodiments of the invention will be further described in details hereinafter with reference to the drawings and specific examples.

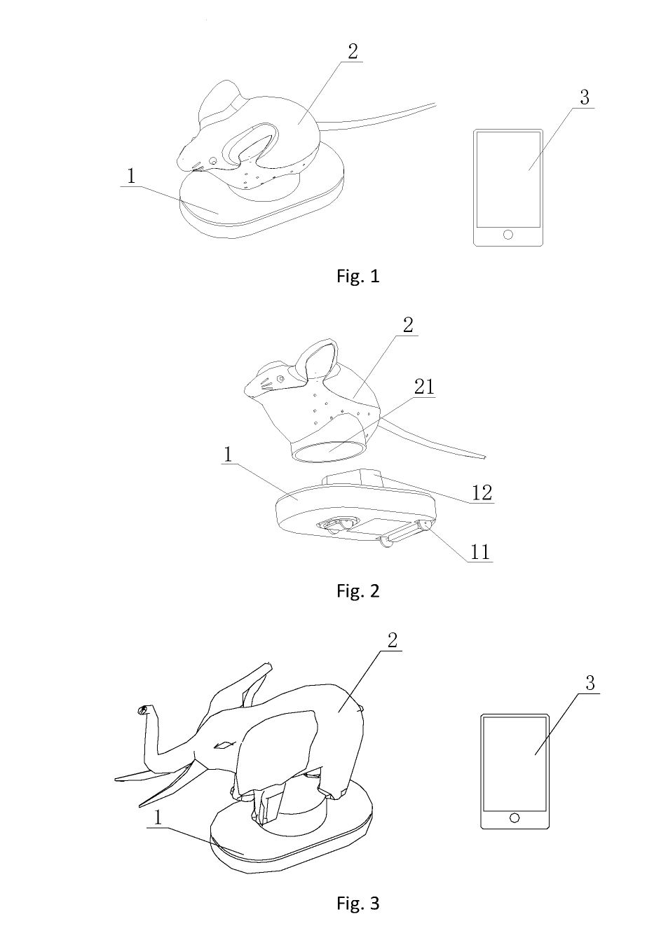

As shown in FIG. 1, a configuration-variable remote-controlled pet toy includes a movable base 1, an animal model 2 detachably installed on the base 1, and an external control terminal 3.

The bottom of the base 1 is provided with a roller wheel 11, the inside of the base 1 is provided with a motor, a control circuit, a micro control unit, a wireless communication module and a phonation device. The motor is configured to drive the roller wheel 11 to roll, the control circuit controls the rotation of the motor according to a control signal sent by the micro control unit, the wireless communication module is communicated with the external control terminal 3, and the phonation device is configured to play the sound or sound record of a master received by the wireless communication module in real time. Wherein, the wireless communication module communicates via WiFi or bluetooth.The external control terminal 3 is a movable control terminal, wherein a smartphone or a tablet may be usually used as the movable control terminal.

The head of the animal model 2 is provided with a wireless camera lens that can be communicated with the external control terminal. The wireless camera lens is detachably installed on the head of the animal model 2.

As shown in FIG. 2, the top of the base 1 is provided with an installation column 12 which is vertically raised towards the upper side, and the bottom of the animal model 2 is provided with a recess platform 21 corresponding to the installation column 12. The animal model 2 is fixed on the base 1 through the buckling of the recess platform 21 and the installation column 12.

When in use, the animal model is installed on the base, and the running of the toy is controlled via a mobile phone or a tablet, so as to attract the pet to chase the toy. The camera lens can shoot the interaction process between the pet and the toy, and sends the shot video to the screen of the mobile phone or the tablet of the master, so that the master can view the playing situation of the pet in real time. Moreover, the master can talk to the mobile phone or the tablet, which can be sent to the toy through wireless communication, and then played by the phonation device, so as to interact and communicate with the animal, and enhance the interesting property of the toy.

When the pet loses interest on one pet model, the pet model can be replaced, which is as shown in FIG. 3, to attract the attention of the pet again.

The toy can replace the master to play and communication with the pet to a very great extent, and is particularly suitable for old people to raise pets, and avoid the old people from spending overmuch vigor on teasing the pet.

What is claimed is:

1. A configuration-variable remote-controlled pet toy, comprising a movable base (1), an animal model detachably installed on the base, and an external control terminal, wherein:
the bottom of the base is provided with a roller wheel, the inside of the base is provided with a motor, a control circuit, a micro control unit, a wireless communication module and a phonation device; the motor is configured to drive the roller wheel to roll, the control circuit controls the rotation of the motor according to a control signal sent by the micro control unit, the wireless communication module is communicated with the external control terminal, and the phonation device is configured to play the sound or sound record of a master received by the wireless communication module in real time.

2. The configuration-variable remote-controlled pet toy according to claim 1, wherein the head of the animal model is provided with a wireless camera lens that can be communicated with the external control terminal.

3. The configuration-variable remote-controlled pet toy according to claim 2, wherein the wireless camera lens is detachably installed on the head of the animal model.

4. The configuration-variable remote-controlled pet toy according to claim 1, wherein the top of the base is provided with an installation column which is vertically raised towards the upper side, and the bottom of the animal model is provided with a recess platform corresponding to the installation column; and the animal model is fixed on the base through the buckling of the recess platform and the installation column.

5. The configuration-variable remote-controlled pet toy according to claim 1, wherein the base is provided with a battery installation box that can be downwards opened.

6. The configuration-variable remote-controlled pet toy according to claim 1, wherein the wireless communication module communicates via WiFi or bluetooth.

7. The configuration-variable remote-controlled pet toy according to claim 1, wherein the external control terminal is a movable control terminal.

8. The configuration-variable remote-controlled pet toy according to claim 1, wherein the movable control terminal is a smartphone or a tablet.
